(19) United States
(12) Patent Application Publication
(10) Pub. No.: US 2006/0045949 A1
(43) Pub. Date: Mar. 2, 2006

(54) Silicon devices and method for cooking with silicone devices

(76) Inventor: Kevin William McLaughlin, Oakland, CA (US)

Correspondence Address: Sharon J. Adams;#230, 1867 Ygnacio Valley Rd., Walnut Creek, CA, 94598, US

(21) Appl. No.: 10/928,461

(22) Filed: Aug. 27, 2004

(51) Int. Cl. A22C 13/00

(52) U.S. Cl. 426/420

(57) ABSTRACT

The invention involves silicone devices and a method for using the silicone devices for food preparation and for cooking. The silicone devices come in a variety of shapes: bands, string, mesh, perforated sheets, connected double-Os, and film. The silicon devices may be used when food is prepared, then frozen and later cooked; to support food during cooking; or in food preparation when the food is not heated. The silicon devices may be stretched and placed over a food item prior to cooking and will support the food item during cooking. The silicone devices retain their elasticity when exposed to heat and continue to hold the food in shape while cooking. After cooking is complete, the silicone devices are quickly and easily removed from the food without sticking to the food.

### CROSS REFERENCE TO RELATED APPLICATIONS

Not Applicable.

### FEDERAL SPONSORSHIP

Not Applicable.

### BACKGROUND

The invention uses different silicone devices in cooking. Silicone is ideal for use in cooking because it maintains its flexibility over a wide range of temperatures, from freezing to high temperature cooking, without breaking down. Unlike rubber-based products, silicone is inert and imparts no flavor or residue to food. The silicone devices are easy to learn to use, and easy to use. They can be stretched to hold and support a variety of foods for a variety of food preparation purposes.

Cooks and chefs use many different devices to secure meat, poultry, fish, vegetables and other food before and during the cooking process. For example, a lamb shank or osso bucco must be tied before braising. Vegetables, for example leeks, are often bundled before cooking. Typically the food item is tied with twine or string prior to cooking. Twine is used because meat tends to fall apart and fall away from the bone as it cooks. The twine holds the meat in place. However, it takes time to tie each food item. And, it takes time to train new chefs how to properly tie food. The silicone devices are easy to learn to use and easy to use. They may be quickly stretched and placed over the food item, removing the need for tying. Saving time is especially important in the restaurant business. The silicone bands save time both in chef training and during day-to-day operations.

During cooking, twine absorbs juices and oils from the food. The twine and meat will frequently interact and the twine will stick to the food. The twine also may assume the color of the food. After cooking is complete, chefs typically cut and remove the twine from the meat prior to serving. However, it is often difficult to find and remove the twine after cooking because the twine has become colored with and enmeshed with the food. Rubber-based products cannot be used because rubber breaks down at temperature, and may impart foul tastes or toxins to the food.

In addition, twine or string is not optimal for grilling because it may catch on fire during grilling. Currently, when grilling meat chefs use skewers or toothpicks. When grilling vegetables chefs typically soak the twine in water, then tie the twine around the vegetables prior to cooking. The silicone devices are inflammable. There is no need to soak them in water prior to grilling, and the silicone bands may be placed on the food without tying.

Previous attempts have not solved these problems. U.S. Pat. No. 3,823,442 teaches that an elasticized band covered with tightly woven fabric may be used to hold meat during cooking. However, the fabric covering interacts with the cooking meat and will stick to the meat, making removal of the fabric bands difficult. U.S. Pat. No. 6,308,617 teaches the use of a machine for binding roasts with elastic rings. However, the use of a machine is cumbersome and can only be used for roasts.

Neither of these patents suggest that chefs use silicone devices to rapidly prepare food and to support the food during cooking. Neither of these patents combine the time-saving features of silicone devices with the non-stickiness of the silicone devices.

The prior art also discloses a number of devices that may be used to retain poultry hocks during cooking. For example U.S. Pat. No. 3,895,415, U.S. Pat. No. 4,056,865, U.S. Pat. No. 4,056,865, U.S. Pat. No. 5,112,274, U.S. Pat. No. 5,279,519, U.S. Pat. No. 5,735,736, U.S. Pat. No. 5,749,778, and U.S. Patent application No. 2003/0186640 all teach a variety of devices that may be used for retaining poultry hocks during cooking. Many of these devices are complicated and difficult to position on the poultry hock, and are similarly difficult to remove once cooking is complete. Rather than using any of these devices, the silicone string, bands or silicone connected double-O may be quickly and easily placed around the poultry hock prior to cooking and, after cooking is complete, quickly released without sticking to the food item.

In addition, chefs frequently use cheesecloth when poaching fruit, or other foods. The cheesecloth is typically wrapped around the food to prevent the food from losing shape, settling and touching each other during cooking. However, cheesecloth, like twine, frequently sticks to the food and is difficult to remove after cooking is complete. The silicone mesh or silicone perforated sheets can be wrapped around the food and will function like cheesecloth. However, the silicone mesh will not interact with the food and is easily removed after cooking.

Chefs also use polyethylene, polyvinylidene chloride, vinyl, or other similar wrap, especially when preparing food that is frozen and cooked later. However, polyethylene, polyvinylidene chloride, vinyl, or other wrap breaks down when exposed to heat and may impart residues to the food. Many of these wraps are not indicated for direct contact with food. In addition, these wraps cannot be used in ovens. The silicone film may be used any circumstances in which polyethylene, polyvinylidene chloride, vinyl, or other similar wrap is used, and in the oven. The silicone film may have direct contact with food, remains inert during cooking, and will not break down during cooking.

### SUMMARY OF THE INVENTION

The invention uses a variety of silicone devices for food preparation and for cooking. Silicone is approved for use with food. Unlike many types of elastics, rubbers, and other compounds, silicone will not react with food during cooking. Silicone is inert even at very high temperatures. The silicone devices are easy to use. They may be quickly placed on the food prior to cooking and may be used to help the food retain its shape during cooking. Silicone will not stick to food even after thorough heating. Therefore, the silicone devices are quickly and easily removed after cooking.

The silicone devices may be used during food preparation to hold or cover food that is to be frozen. The frozen food and silicone devices may be taken directly from the freezer and then exposed to heat during cooking. The silicone devices will retain elasticity and will not react with the food.

The silicone devices may be used for food preparation even when the food is not cooked, or is pre-cooked. For example, caterers may use the silicone bands to pre-portion food prior to serving. The caterer may take the pre-portioned food, cut the silicone band, and place the food portion on the plate.

These features are important to the commercial cooking industry where saving small amounts of time on each food item can result in large costs savings to the restaurant, cafeteria or caterer. The ease of use of the silicone devices is helpful to the home chef, as well.

The silicone devices come in a variety of shapes for different uses: silicone string; silicone bands; silicone connected double-Os; silicone mesh; silicone perforated sheets; and silicone film. All of these devices may be reused, or they may be disposable. Optionally, the silicone devices may be brightly colored so that they can be easily seen and removed after cooking.

### DESCRIPTION OF THE DRAWINGS

FIG. 1 is a plan view of a silicone band.

FIG. 2 is a cross-sectional view of silicone string.

FIG. 3 is a plan view of a connected double-O.

FIG. 4 is a plan view of silicone mesh.

FIG. 5 is a perspective view of a silicone perforated sheet.

FIG. 6 is a perspective view of a silicone film.

FIG. 7A is a side view of a silicone tube with two open ends.

FIG. 7B is a side view of a silicone tube with one open end.

FIG. 8 is a side view of the method of using silicone bands on a lamb shank.

FIG. 9 is a side view of the method of using silicone bands to close a poultry cavity.

FIG. 10 is a side view of the method of using the silicone mesh to poach fish.

FIG. 11 is a side view of the method of using the silicone perforated sheet to poach a pear.

FIG. 12 is a side view of the method of using the silicone file between lasagna and aluminum foil.

### DETAILED DESCRIPTION OF THE INVENTION

Silicone cooking devices have many advantages. Silicone is approved for use with food. See Title 21, Part 177, Section 2600 of the Code of Federal Regulations. Silicone is inert and will not react with food even at high temperatures. Depending on the formulation, silicone can be flexible; it can expand and contract as needed to accommodate positioning the silicone device on the food. Silicone retains its flexibility even at high temperatures and can accommodate food expansion and shrinkage during cooking. Silicone is non-stick and is typically easily removed from food after cooking is complete without causing the food to stick to the silicone device. Because the silicone devices are flexible, inert and non-stick, they may be sanitized and reused.

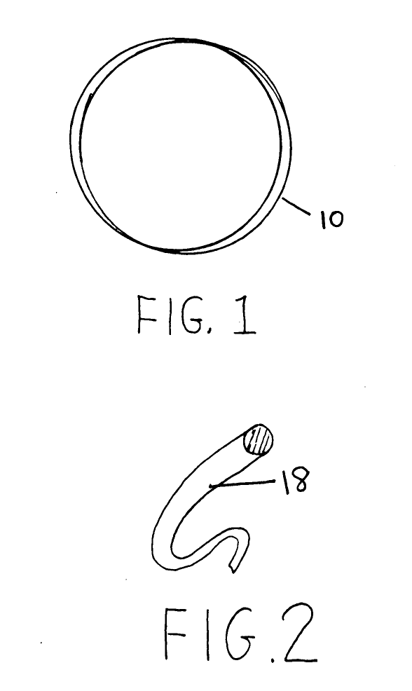

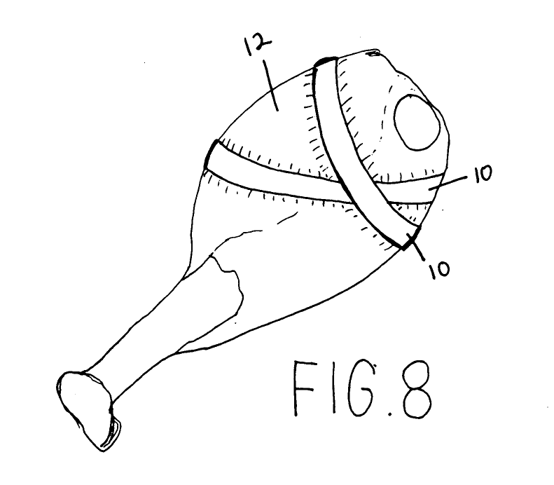

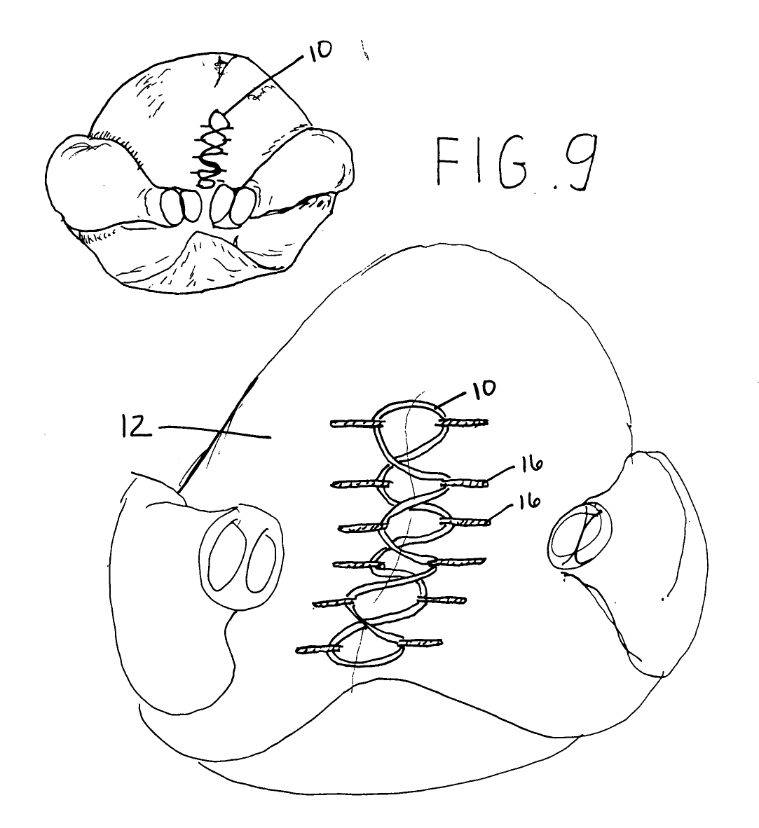

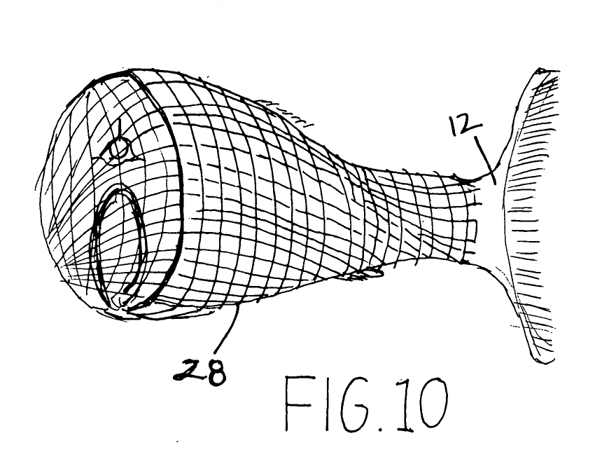

FIG. 1 shows a silicone band 10. As shown in FIG. 8, one or more silicone bands 10 may be positioned around a food item 12, in this case a lamb shank. For use with a lamb shank, the inventor currently prefers using two or three silicone bands of approximately 3 inches diameter, and ¼ inch cross-sectional thickness. However, the silicone band may come in any variety of diameters and thicknesses, depending on the particular food and cooking technique used. As shown in FIG. 9, a larger diameter silicone band may be used for trussing poultry. FIG. 1 shows a silicone band with a circular cross-section. However, the silicone band may have a square, rectangular, triangular or any other cross-sectional shape.

FIGS. 8 and 9 show the silicone bands 10 positioned on the food items 12. The flexibility of the silicone bands will allow the silicone bands 10 to be stretched over the food item 12 and positioned on the food item. The silicone bands 10 will retract and compress the food item, thereby helping the food item to retain its shape. The silicone bands 10 retain flexibility at extremely high temperatures, and will expand and contract in concert with any expansion or contraction of food item 12 during the cooking process. Once the cooking is complete, the silicone bands 10 and accompanying food item 12 are removed from the heat source. The silicone bands 10 are released from the food item 12. Typically, the silicone bands 10 are released by simply cutting the bands with a knife or scissors. The elasticity of the silicone bands will cause the silicone bands to contract and pull away from the food item after cutting the silicone bands. Food item 12 will not stick to the silicone bands 10 because the silicone bands are inert. After releasing, the silicone bands are easily removed from the food item 12 by simply pulling the silicone bands 10 from the food item 12.

FIG. 9 shows the use of a larger diameter silicone band for trussing poultry. In this case, the inventor prefers to use a 5-7 inch diameter silicone band. The silicone band 10 is placed alongside the poultry carcass 12, and toothpick 16 is used to pierce the two sides of poultry cavity. The silicone band 10 is positioned behind toothpick 16 and in front of the poultry. The silicone band 10 is then twisted and another toothpick 16 is used to pierce the two sides of the poultry cavity. The silicone band 10 again is positioned behind the toothpick 16 and in front of the poultry. The number of toothpicks used and the number of twists in the silicone band is dependent upon the size of the poultry and the diameter of the silicone band.

Another embodiment of the invention is shown in FIG. 2, the silicone string 18. The silicone string 18 may come in any length, and may be cut to any desired length depending on the cooking needs. For example, silicone string 18 may be used instead of the silicone bands 10 to truss poultry, or to tie roasts. The inventor currently prefers using solid silicone string, as shown in FIG. 2. However, the silicone string may be hollow in the middle, as is typical of silicone tubing. The presence or absence of a hollow core will not affect the use of the device. Like the silicone bands, the silicone string may have any cross-sectional shape.

The silicone string 18 is positioned on a food item by stretching and wrapping the silicone string 18 around a food item and tying it in place. The silicone string 18 will expand and contract with the food item. After cooking is complete the silicone string and food item are removed from the heat source. The silicone string is released either by cutting or untying, and is easily removed from the food by pulling one end of the silicone string 18.

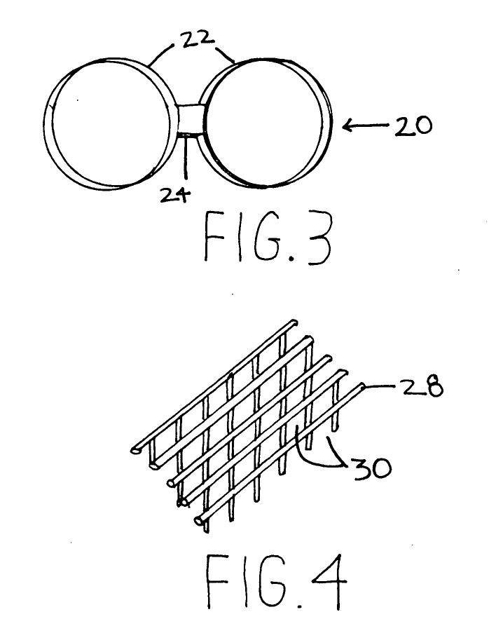

The connected double-O 20 is a unitary silicone structure, as shown in FIG. 3. The connected double-O 20 is designed for use on poultry hocks 26. The connected double-O 20 is positioned around the ankle joints of poultry hocks prior to cooking, as shown in FIG. 3. When cooking a chicken the inventor currently prefers using a connected double-O 20 in which each O 22 is ⅝″ diameter, and the connecting bar 24 is approximately ¼″ long. However, the size of the O 22 and the connecting bar 24 may be varied to accommodate larger poultry such as turkey, or smaller poultry such as game hens. After cooking is complete, the connected double-O 20 and food item 12 are removed from the heat source. The connected double-O 20 is released and removed from the poultry by cutting with a knife or scissors and pulling the connected double-O 20 from the poultry hock. Alternatively the connected double-O 20 may be released and removed by stretching and pulling the device from the poultry hock.

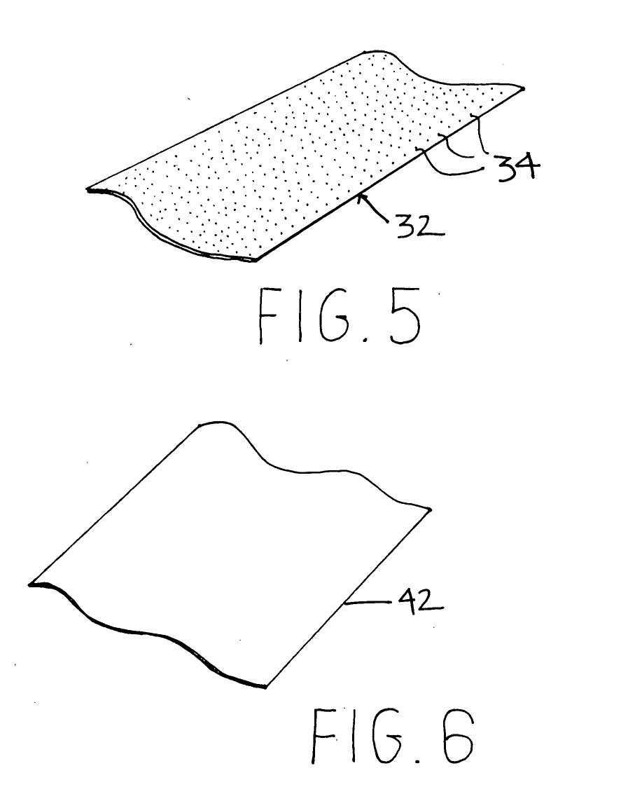

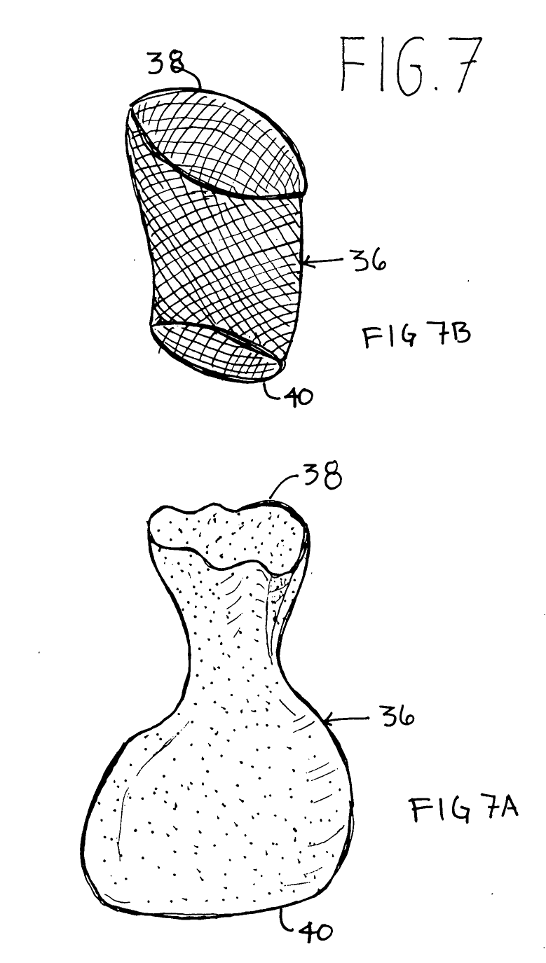

FIG. 4 shows the silicone mesh 28. The silicone mesh 28 is an interlocking pattern of silicone forming essentially square or rectangular interstitial spaces 30. The size and shape of the interstitial spaces 30 can be varied as needed for different cooking or food preparation techniques. Currently, the inventor prefers that the mesh have an interstitial space of ⅛ inch, and a thickness of approximately 1/32 inch. However, the size of the interstitial space and the mesh thickness can be varied, as needed. The mesh may come in sheets, or in roll form.

FIG. 5 shows the silicone perforated sheet 32. The silicone perforated sheet 32 may come in any shape and thickness, and can be varied depending on the food preparation and cooking needs. The sheets 32 may be cut, as needed by the chef prior to use. Currently, the inventor prefers to use silicone perforated sheets that are approximately 1/32 inch thick, and approximately 20 inches square. This size is convenient to work with, and may be cut to the appropriate size. Alternatively, the sheets may come in a large roll, with a width of either 16 or 24 inches.

The silicone perforated sheets are covered with a plurality of holes 34. The size of the holes may be varied, as needed. Currently, the inventor prefers to have approximately 200 of holes per inch, with each hole being the size of a pinprick. However, any number of holes per inch, and any diameter hole may be used to suit a variety of cooking needs

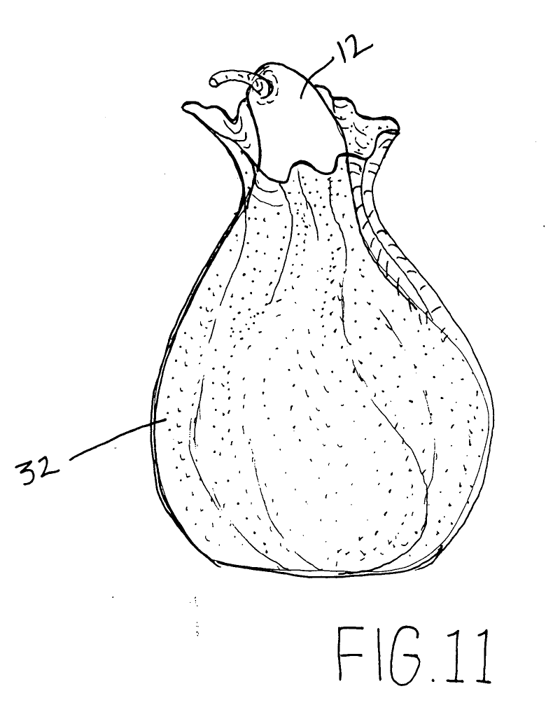

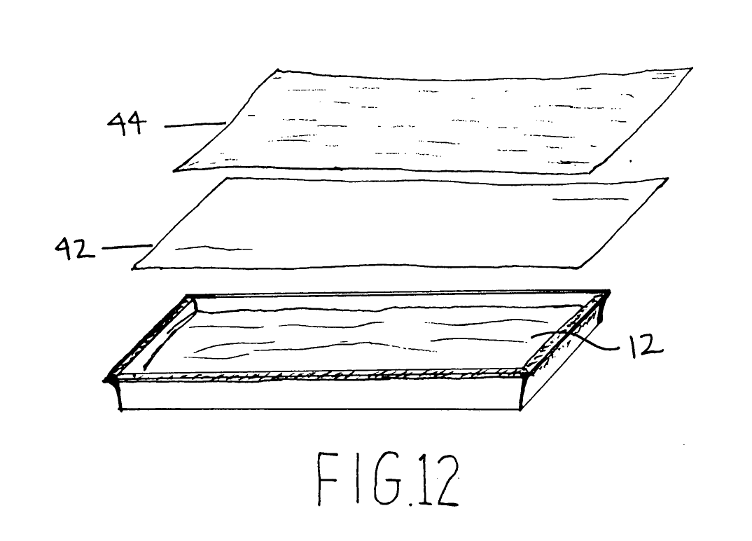

Either the silicone mesh or the silicone perforated sheets may be used whenever cheesecloth is used in cooking. For example, cheesecloth is frequently used to braise meat, poach fish, poach dessert fruits, or to prepare chicken galantine. In every situation, instead of using cheesecloth, the chef may use the silicone mesh or the silicone perforated sheet. For example, the mesh 28 may be used to poach a food item 12. As shown in FIG. 10 the mesh is positioned so that it supports fish during poaching. Similarly, the perforated sheet 32 may be used to poach a food item 12. As shown in FIG. 11 the silicone perforated sheet 32 is positioned to support a dessert pear during poaching.

The silicone mesh or perforated sheets may be positioned to hold and support the food item during cooking. The silicone mesh or perforated sheets are easily released and removed after cooking, without imparting and toxins, residue, or taste to the food item. The silicone perforated sheets or silicone mesh may be released and removed from the food item by cutting and pulling the silicone device from the food item, or by stretching and pulling the silicone device from the food item.

In another embodiment, as shown in FIG. 7, the silicone mesh or perforated sheets are tube-shaped 36, with a first end 38 and a second end 40. The tube-shaped silicone device 36 may have a first end that is open, and a second end that is closed as shown in FIG. 7B. Alternatively, the tube-shaped silicone device 36 both the first end 38 second end 40 may be open, as shown in FIG. 7A. The tube-shaped device 36 provides rapid support for food items. For example, the tube-shaped device 36 may be positioned on a lamb shank by slipped the tube-shaped device 36 around a lamb shank prior to cooking. After cooking is complete, the silicone device is released and removed from the food item by cutting and pulling the silicone device from the food item, or by stretching and pulling the silicone device from the food item.

Instead of using polyethylene, polyvinylidene chloride, vinyl, or other similar wrap, a chef may use any of the silicone devices for food that is prepared and frozen for later use. Polyethylene, polyvinylidene chloride, vinyl, or other similar wrap is not designed for use at high temperatures, and breaks down during cooking. Any of the silicone devices, and particularly the silicone film 42, may be used in place of polyethylene, polyvinylidene chloride, vinyl, or other similar wrap wrap.

Institutional chefs frequently prepare large quantities of food that is frozen prior to use. For example, an institutional chef may prepare several trays of lasagna. Typically, the trays are covered in polyethylene, polyvinylidene chloride, vinyl, or other similar wrap, then wrapped in aluminum foil and frozen. Chefs use polyethylene, polyvinylidene chloride, vinyl, or other similar wrap because the acid in the tomato sauce will interact with and dissolve aluminum foil if the tomato sauce is in direct contact with the aluminum foil. The lasagna trays are frequently removed from the freezer and placed in the oven without removing the polyethylene, polyvinylidene chloride, vinyl, or other similar wrap.

Polyethylene, polyvinylidene chloride, vinyl, and other similar wraps break down when exposed to heat and may impart toxins to the lasagna. Rather than use these wraps, a chef may position the silicone film 42 by stretching or laying the silicone film 42 over the food item 12 that is to be frozen, as shown in FIG. 12, and then freezing the food item along with the silicon film. Aluminum foil 44 may be placed on top, if needed. The silicone film 42 is inert during cooking and can go from freezer to oven without breaking down. After cooking is complete, the food item and silicon film are removed from the oven. The silicone film 42 is released from the food item 12 by cutting with knife or scissors and pulling the silicone film 42 from the food item 12, or by lifting and pulling the silicone film 42 from the food item 12.

The silicone devices may also be used in food preparation, even when the food is not exposed to heat. For example, jams, jellies, yogurt and other items are frequently strained during preparation. The silicone mesh or perforated sheets may be used to strain food by positioning the silicone mesh or perforated sheet so that the food item strains through the silicone device. Similarly, a caterer may use the silicone bands to pre-portion food prior to serving by positioning the silicone devices on food items prior to the catered event. At the catered event, the caterer may release the silicone devices from the food items by cutting and removing the silicone devices. Each food item is then placed on a separate plate.

The silicone devices may optionally be colored so that the chef may quickly find and release the silicone devices. The silicone devices may optionally be sterilized and reused, or may be discarded after one use.

What is claimed is:

1. A method for cooking with one or more silicone devices comprising the steps of:
positioning one or more silicone devices on a food item prior to cooking wherein the silicon device is selected from the group consisting of silicone string, silicone bands, silicone mesh, silicone perforated sheets, silicone connected double-O, or silicone film;
subjecting the food item and accompanying silicone device to a heat source and thereby cooking the food item;
removing the food item and accompanying silicone device from the heat source;
releasing the silicone device from the food item;
removing the silicone device from the food item.

2. The method of claim 1 wherein the silicone device is colored so that it can be easily distinguished from the food item.

3. The method of claim 1 wherein the silicone device is disposed of after one use.

4. The method of claim 1 wherein the silicone device is sanitized and reused.

5. The method of claim 1 wherein the connected double-O is stretched and positioned around the ankle joints of poultry hocks prior to cooking.

6. A method for cooking with one or more silicone devices comprising the steps of:
preparing one or more food items for cooking;
positioned one or more silicone devices on each food item wherein the silicon device is selected from the group consisting of silicone string, silicone bands, silicone mesh, silicone perforated sheets, silicone connected double-O, or silicone film;
freezing the food item and accompanying the silicone device;
removing the food item and accompanying silicone device from the freezer;
subjecting the food item and accompanying silicone device to a heat source;
removing the food item and accompanying silicone device from the heat source;
releasing the silicone device from the food item;
removing the silicone device from the food item.

7. The method of claim 6 wherein the silicone device is colored so that it can be easily distinguished from the food item.

8. The method of claim 6 wherein the silicone device is disposed of after one use.

9. The method of claim 6 wherein the silicone device is sanitized and reused.

10. A method for food preparation with one or more silicone devices comprising the steps of:
positioning one or more silicone devices on a food item wherein the silicon device is selected from the group consisting of silicone string, silicone bands, silicone mesh, silicone perforated sheets, silicone connected double-O, or silicone film;
releasing the silicone device from the food item;
removing the silicone device from the food item.
removing the silicone device from the food item.

11. The method of claim 10 wherein the silicone device is colored so that it can be easily distinguished from the food item.

12. The method of claim 10 wherein the silicone device is disposed of after one use.

13. The method of claim 10 wherein the silicone device is sanitized and reused.

14. A device for cooking comprising a silicone mesh with an interlocking pattern of silicone forming a plurality of essentially square interstitial spaces.

15. A device for cooking comprising a silicone perforated sheet with a plurality of pinprick holes.

16. A device for cooking poultry comprising a unitary silicone structure with a first substantially O-shaped member;
a second substantially O-shaped member;
a connecting bar connecting the first O-shaped member to the second O-shaped member.

17. A device for cooking comprising a silicone tube with a first end and a second end wherein the first end and the second end are both open;
a plurality of pinprick holes or interstitial spaces on the silicone tube.

18. The device of claim 17 wherein the second end is closed and is covered with a plurality of pinprick holes or interstitial spaces.
